(19) United States
(12) Patent Application Publication
(10) Pub. No.: US 2011/0056579 A1
(43) Pub. Date: Mar. 10, 2011

(54) Temporary sealer for pipe repair and construction

(76) Inventors: Lincoln Tsai, El Monte, CA (US); Benn Tsai, El Monte, CA (US)

(21) Appl. No.: 12/584,457

(22) Filed: Sep. 4, 2009

(51) Int. Cl. F16L 55/11; F16L 55/18; F16K 17/40

(52) U.S. Cl. 138/89; 138/97; 137/68.23; 137/68.27

(57) ABSTRACT

A temporary sealer for pipe repair and construction includes a sealing head, and a breakable film. The sealing head has a tubular shape and a size and shape corresponding to an inner diameter of a pipe. The breakable film is formed at the sealing face of the sealing head, wherein the breakable film forms a water barrier for temporarily restricting a flow of water passing through the sealing head within the pipe when the sealing head is slid into the pipe. The breakable film is inevitably torn apart in responsive to a predetermined water pressure for enabling the water flow passing through the sealing head within the pipe. Therefore, it not only provides a way to efficiently block the water flow when the water pipe needs construction, but also provides an apparatus involving the flow system when the water pipe system is finished with construction.

### BACKGROUND OF THE PRESENT INVENTION

1. Field of Invention

The present invention relates to a pipe sealing device, and more particularly to a temporary sealer for pipe repair and construction, wherein the temporary sealer is adapted for not only temporarily restricting a flow of water flowing into the pipe during pipe repair and construction, but also allowing water flow passing the pipe after the pipe repair or construction is finished without removing the temporary sealer.

2. Description of Related Arts

Due to serious rainfall and water diversity uneven problems, water pipes are often to be repaired. It includes not only the new water pipe construction for new water supply, but also includes broken or out of date water pipe replacement or remolding.

For repairing a broken water pipe, the workman must switch off the water source for stopping the water flowing to the broken water pipe before the broken water pipe is removed. In order to better repair the water pipe, the workman usually needs to remove the water within the pipe and swipe out the residual water through the water absorption material such as cotton, a wiper, and so on. And then, the broken section of the water pipe is generally cut off from the water pipeline, otherwise people can try to find appropriate adhesive layer sealing on the broken section of the water pipe.

However, even though the workman already shuts off the water source to disconnect the supply of the water, the residual water within the water is still running out. The water spurted from the water pipe and streamed on to the floor. It not only wastes a lot of water, but also leads to a much unsafe working environment to the workmen.

Moreover, the workman needs to constantly wipe out the water within and on the surface the pipe through absorbing material in order to keep the water pipe dry. If the absorbing material used in wiping out the water carries some unnecessarily dust or germ, dust and germ can deposit onto water pipe very easily. Once the water pipe is done with the repair, the water comes with the dust and germ will threaten the health of body. It is believed that water after pipe construction is not clean anymore. In addition, since the residual water within the water pipe is keep running, the inner and outer surface of the water pipe is always wet. The pipe may not be easily to be cut and repair such that the workman needs to replace the entire section of the water pipe. In other words, the water pipe is not dry enough and hard for people to make a securely replacement. It dramatically increases the material cost of the water pipe. Therefore, an improved apparatus for temporary blocking the water pipe when the water pipe is broken should be developed to meet the demands of the water pipe repair and construction.

### SUMMARY OF THE PRESENT INVENTION

A main object of the present invention is to provide a temporary sealer for pipe repair and construction, wherein the temporary sealer is adapted for not only temporarily restricting a flow of water flowing into the pipe during pipe repair and construction, but also allowing water flow passing the pipe after the pipe repair or construction is finished without removing the temporary sealer.

Another object of the present invention is to provide comprises a breakable film forms a water barrier for temporarily restricting a flow of water flowing into the pipe during pipe repair and construction. Once the water pipe is fixed, the breakable film can be broken by the water pressure for immediately allowing water flow passing the pipe. In other words, the temporary sealer not only provides a way to efficiently block the water flow when the water pipe needs construction, but also provides an apparatus involving the flow system when the water pipe system is finished with construction.

Another object of the present invention is to provide a temporary sealer for pipe repair and construction, wherein the breakable film has an uneven thickness to define a strengthen portion and a weakness portion such that the weakness portion of the breakable film is capable of torn apart in responsive to the water pressure to activate the water flowing when the water pipe is finished repairing. Therefore, a temporary sealer is naturally breakthrough for allowing the water flowing into the water pipe so as to simplify the steps when the water pipe repair and construction is finished.

Another object of the present invention is to provide a temporary sealer for pipe repair and construction, wherein the sealing head has a ring shape and defines a reinforcing rim at the sealing face such that the breakable film is more secure when the sealing head is slid along the pipe.

Another object of the present invention is to provide a temporary sealer for pipe repair and construction, wherein the breakable film forms a water barrier for temporarily restricting a flow of water passing through the sealing head not only eliminates the steps to always keep swiping out the water through absorbing material flowing within the water pipe, but also reduces the chance of the unnecessary contact between the absorbing material and the water pipe to avoid unintentional pollution.

Another object of the present invention is to provide a temporary sealer for pipe repair and construction, wherein the temporary sealer comprises a retention ring having a size and shape corresponding to the inner diameter of a pipe, and an extension frame extended between the sealing head and the retention ring such that the orientation of the temporary sealer is capable of always keep upright towards the pipe.

Another object of the present invention is to provide a temporary sealer for pipe repair and construction, wherein a plurality of extension arms spacedly extended from the sealing head to the retention ring to define a water passage such that no matter how strong or how uneven the compound force the water applied to the temporary sealer, the water is still able to passing through the water passage when the breakable film is torn apart.

Another object of the present invention is to provide a temporary sealer for pipe repair and construction which is convenient to be installed on the water pipe and is capable of achieve the goal of water and water pipe material saving.

Accordingly, in order to accomplish above objects, the present invention provides a temporary sealer for pipe repair and construction, comprising a sealing head, and a breakable film.

The sealing head comprises a tubular shape and defines a sealing face, which has a size and shape corresponding to an inner diameter of a pipe. The breakable film is formed at the sealing face of the sealing head, wherein the breakable film forms a water barrier for temporarily restricting a flow of water passing through the sealing head within the pipe when the sealing head is slid into the pipe. Accordingly, the breakable film is inevitably torn apart in responsive to a predetermined water pressure for enabling the water flow passing through the sealing head within the pipe. Therefore, the breakable film forms a water barrier not only for temporarily restricting a flow of water flowing into the pipe during pipe repair and construction, but also for allowing water flow passing the pipe when the pipe repair or construction is finished.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a temporary sealer for pipe repair and construction according to a first preferred embodiment of the present invention.

FIG. 2 is a sectional view of the temporary sealer for pipe repair and construction according to the above first preferred embodiment of the present invention, illustrating the temporary sealer being slid in the water pipe.

FIG. 3 is a perspective view of the temporary sealer for pipe repair and construction according to the above first preferred embodiment of the present invention, illustrating the breakable film being torn apart.

FIG. 4 is a perspective view of a temporary sealer for pipe repair and construction according to a second preferred embodiment of the present invention, illustrating the alternative mode of the extension frame and the breakable film.

### DETAILED DESCRIPTION OF THE PREFERRED EMBODIMENT

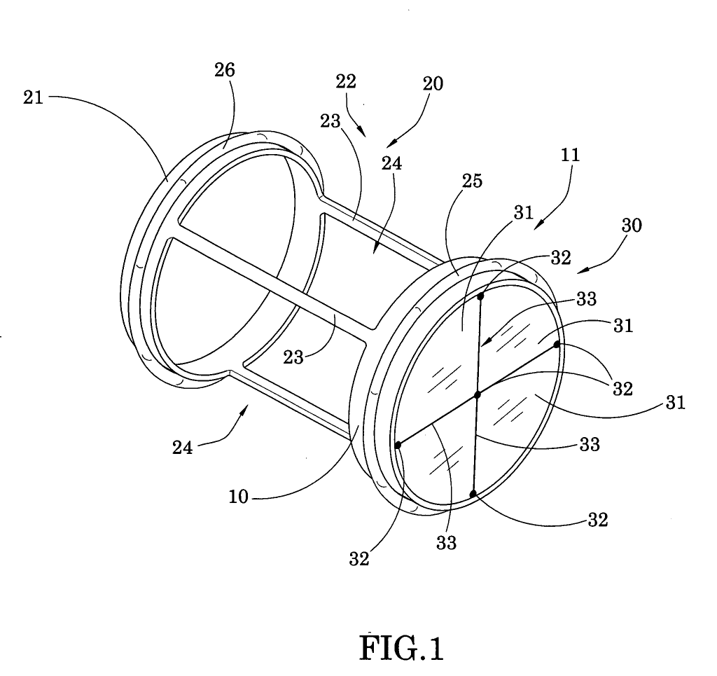

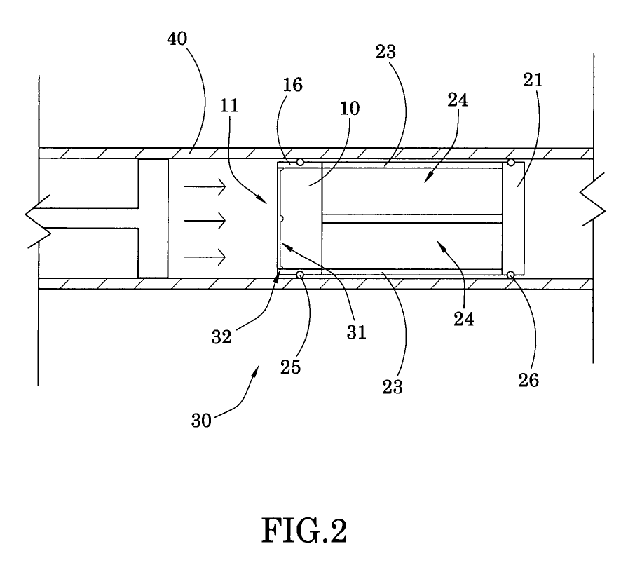

Referring to FIG. 1 to FIG. 2 of the drawings, a temporary sealer for repair and construction according to a preferred embodiment of the present invention is illustrated, in which the temporary sealer comprises a sealing head 10, a breakable film 30.

The sealing head 10 is adapted to slide within a pipe 40, such as a water pipe, to coaxially seal therein. The sealing head 10 comprises a tubular shape and defines a sealing face 11 thereat, wherein the sealing head 10 has a size and shape corresponding to an inner diameter of the pipe 40.

The breakable film 30 is formed at the sealing face 11 of the sealing head 10, wherein the breakable film 30 forms a water barrier for temporarily restricting a flow of water passing through the sealing head 10 within the pipe 40 when the sealing head 10 is slid into the pipe 40.

Accordingly, the breakable film 30 is inevitably torn apart in responsive to a predetermined water pressure for enabling the water flow passing through the sealing head 10 within the pipe 40. Therefore, the breakable film 30 forms a water barrier not only for temporarily restricting a flow of water flowing into the pipe 40 during pipe repair and construction, but also for allowing water flow passing the pipe 40 when the pipe repair or construction is finished. In other words, the temporary sealer not only provides a way to efficiently block the water flow when the water pipe 40 needs construction, but also provides an apparatus involving the flow system when the water pipe system is finished with construction.

When the breakable film 30 temporary restricts a flow of water passing through the sealing head 10, a much more dry and stable working environment is available to the workman to get repair and construct with the water pipe. Moreover, because the flow way of the water pipe 40 is blocked by the temporary sealer, the workman doesn't need to constantly wipe out the water within and on the surface the pipe 40 through absorbing material in order to keep the water pipe dry. Finally, it reduces the chance of the unnecessary contact between the absorbing material and the water pipe to avoid unintentional pollution. Moreover, because the water flow is block, there is no extra water waste during the pipe repair and construction. It is much easier for people to cut or repair the broken or the fracture portion of the pipe such that the workman doesn't needs to replace the entire section of the water pipe. In other words, the water pipe is dry enough for repair and easy for people to make a secure replacement so as to achieve the goal of water and water pipe material saving.

Accordingly, the sealing head 10 has a ring shape and defines a reinforcing rim 16 at the sealing face 11 that the breakable film 30 is sealed and mounted at the reinforcing rim 16 for preventing the breakable film 30 being unintentionally torn apart when the sealing head 10 is slid along the pipe. In particularly, the circumferential edge of the breakable film 30 is attached to the inner surface of the sealing head 10 within the reinforcing rim 16 to retain the breakable film 30 in position.

Therefore, the breakable film 30 is more secure because the reinforcing rim 16 strengthens the connection between the breakable film 30 and the sealing head 10 keep the breakable film 30 away falling off from the sealing head 10. In addition, when the sealing head 10 is slid within the pipe 40, a pushing rod is preferably used to push the sealing head 10 into the pipe 40. As shown in FIG. 2, the pusher end of the pushing rod is engaged with the reinforcing rim 16 of the sealing head 10 for preventing the breakable film 30 from being torn apart accidentally when the sealing head 10 is slid within the pipe 40.

According to the preferred embodiment, the breakable film 30 is made of a thin plastic material adapted to resist a predetermined water pressure so as to block the water passing from one side to another side. However, the breakable film 30 can be torn apart when the water pressure is increased.

It is worth to mention that when water pressure applied onto the surface of the breakable film 30, different thickness of the breakable film 30 can bear different level water pressure. Once the water pressure applied on the breakable film 30 is over the maximum the breakable film can stand, the breakable film 30 will break down or torn apart very easy. In other words, when the water source is switched back on to enable the water flowing along the pipe 40, the water pressure will be substantially increased at the breakable film 30 until the breakable film 30 is torn apart.

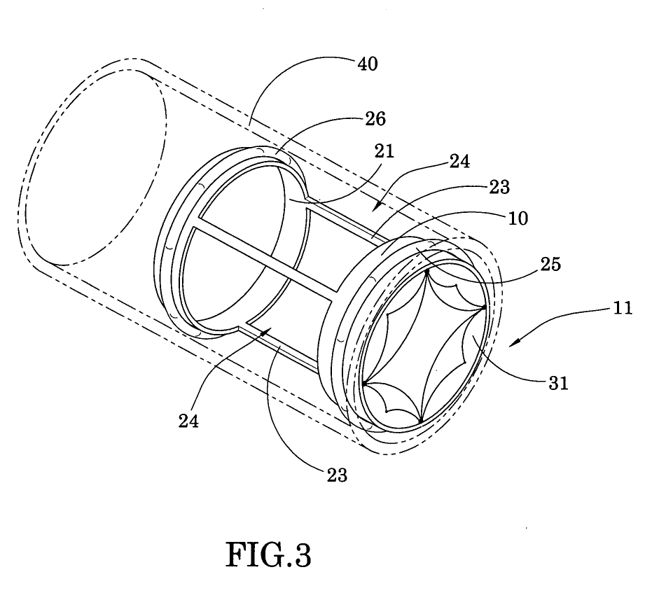

As shown in FIG. 1, the breakable film 30 has an uneven thickness to define a strengthening portion and a weakening portion thinner than the strengthening portion, in such a manner that the weakening portion of the breakable film 30 is started to be torn apart in responsive to the water pressure, as shown in FIG. 3. In other words, a temporary sealer is naturally breakthrough for allowing the water flowing into the water pipe 40 so as to simplify the steps when the water pipe repair and construction is finished.

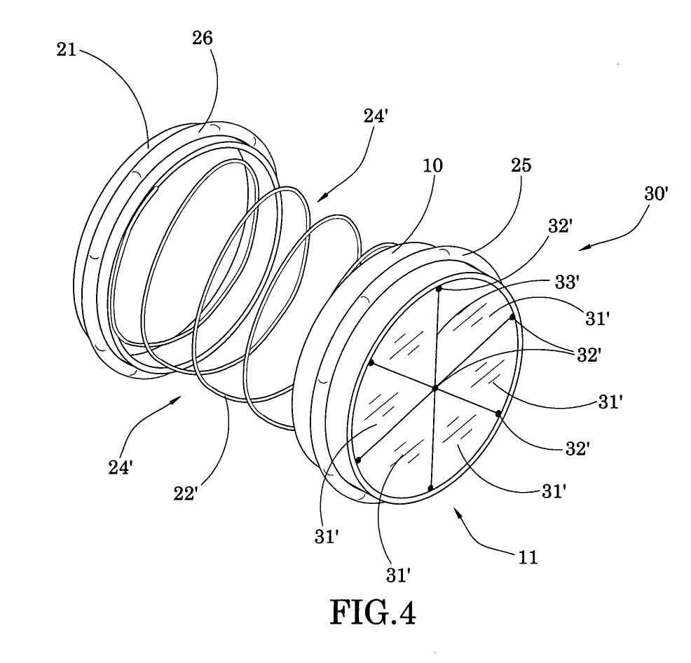

According to the preferred embodiment of the present invention, the weakening portion of the breakable film 30 has a plurality of sector areas 31 evenly formed at the breakable film 30. Referring to FIG. 3 of the drawings, the breakable film 30 is divided into four sector areas 31. The numbers of the sector areas are flexible. Alternatively, six sector areas can be made within the sealing head 10 as shown in FIG. 4.

The strengthening portion of the breakable film 30 has a plurality of strengthening points 32 evenly formed at an outer circumferential portion of the breakable film 30 and formed at a center thereof, and a plurality of strengthening lines 33 evenly formed at a diameter line of the breakable film 30 at a position that each of the strengthening lines 33 passes through the center of the breakable film 30 to meet two corresponding strengthening points 32. Each of the strengthen lines 33 and the strengthen points 32 strengthens the structure of the breakable film 30 enabling the breakable film duration much longer.

According to the preferred embodiment of the present invention, the temporary sealer further comprises a retention frame 20 extended from the sealing head 10 at a direction opposite to the sealing face 11 thereof, wherein the retention frame 20 comprises a retention ring 21 having a size and shape corresponding to the inner diameter of the pipe 40, and an extension frame 22 extended between the sealing head 10 and the retention ring 21, in such a manner that when the sealing head 10 is slid within the pipe, the retention ring 21 is adapted to retain an orientation of the breakable film 30 squaring to the pipe 40. In other words, the orientation of the temporary sealer is capable of always keep its position to coaxial with the pipe 40.

The extension frame 22 comprises a plurality of extension arms 23 spacedly extended from the sealing head 10 to the retention ring 21 to define a water passage 24 between every two neighboring extension arms 23 for enabling the water passing through the water passages 24 when the breakable film 30 is torn apart. It is worth to mention that after the water pressure break through the breakable film 30, the temporary sealer has became one parts of water pipe 40 to transport the water. When the temporary sealer is pushed by the water pressure to torn apart the breakable film 30, the body of the temporary sealer may force to move. No matter what kind of the water pipe structure is, such as the T-shaped three way water pipe, the temporary sealer is capable of keep its orientation to the water pipe 40 and the water is capable of smoothly flowing through the temporary sealer without being stuck within the pipe 40. In other words, no matter how strong or how uneven the compound force the water applied to the temporary sealer, the water is still able to pass through the water passage 24 when the breakable film 30 is torn apart. To sum up, the temporary sealer is applicable to in any kind of the water pipe 40.

As shown in FIGS. 1 and 2, the sealing head 10 further comprises a sealing ring 25 encirclingly coupled at an outer circumferential surface of the sealing head 10 for biasing against an inner wall of the pipe 40 so as to provide a water sealing effect when the sealing head 10 is slid within the pipe 40. For providing a better sealing effect, an addition sealing ring 26 is encirclingly coupled at an outer circumferential surface of the retention ring 21.

As shown in FIG. 4, a temporary sealer of a second embodiment illustrates an alternative mode of the first embodiment of the present invention, wherein the temporary sealer of the second embodiment has the same structural configuration of the first embodiment, except the breakable film 30′ and the extension frame 22′. In other words, FIG. 4 illustrates the alternative mode of the breakable film 30′ and the extension frame 22′ of the first embodiment.

As shown in FIG. 4, the breakable film 30′ also has an uneven thickness to define a strengthening portion and a weakening portion thinner than the strengthening portion, in such a manner that the weakening portion of the breakable film 30′ is started to be torn apart in responsive to the water pressure.

According to the second embodiment, the weakening portion of the breakable film 30′ has a plurality of sector areas 31′ evenly formed at the breakable film 30′. Referring to FIG. 4 of the drawings, the breakable film 30′ is divided into six sector areas 31′.

The strengthening portion of the breakable film 30′ has a plurality of strengthening points 32′ evenly formed at an outer circumferential portion of the breakable film 30′ and formed at a center thereof, and a plurality of strengthening lines 33′ evenly formed at a diameter line of the breakable film 30′ at a position that each of the strengthening lines 33′ passes through the center of the breakable film 30′ to meet two corresponding strengthening points 32′. Each of the strengthen lines 33′ and the strengthen points 32′ strengthens the structure of the breakable film 30′ enabling the breakable film duration much longer.

As shown in FIG. 4, the extension frame 22′ comprises a spiral shaped compression spring 22′ having two ends coupling with the sealing head 10 and the retention ring 21 respectively to define a water passage 24′ between every two spiral portions of the compression spring 22′ for enabling the water passing through the water passages 24′ when the breakable film 30′ is torn apart. It is worth to mention the when the user feels the spring force is exerted at the sealing head 10 at the same when the sealing head 10 is slid within the pipe 40, the user will know the sealing head 10 is stopped within the pipe 40 and will stop pushing the sealing head 10 further within the pipe 40.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A temporary sealer for pipe repair and construction, comprising:
a sealing head, having a tubular shape and defining a sealing face, which has a size and shape corresponding to an inner diameter of a pipe; and
a breakable film formed at said sealing face of said sealing head, wherein said breakable film forms a water barrier for temporarily restricting a flow of water passing through said sealing head within said pipe when said sealing head is slid into said pipe, wherein said breakable film is inevitably torn apart in responsive to a predetermined water pressure for enabling said water flow passing through said sealing head within said pipe.

2. The temporary sealer, as recited in claim 1, wherein said breakable film has an uneven thickness to define a strengthening portion and a weakening portion thinner than said strengthening portion, in such a manner that said weakening portion of said breakable film is started to be torn apart in responsive to said water pressure.

3. The temporary sealer, as recited in claim 2, wherein said weakening portion of said breakable film has a plurality of sector areas evenly formed at said breakable film.

4. The temporary sealer, as recited in claim 2, wherein said strengthening portion of said breakable film has a plurality of strengthening points evenly formed at an outer circumferential portion of said breakable film and formed at a center thereof, and a plurality of strengthening lines evenly formed at a diameter line of said breakable film at a position that each of said strengthening lines passes through said center of said breakable film to meet two corresponding strengthening points.

5. The temporary sealer, as recited in claim 3, wherein said strengthening portion of said breakable film has a plurality of strengthening points evenly formed at an outer circumferential portion of said breakable film and formed at a center thereof, and a plurality of strengthening lines evenly formed at a diameter line of said breakable film at a position that each of said strengthening lines passes through said center of said breakable film to meet two corresponding strengthening points.

6. The temporary sealer, as recited in claim 1, wherein said sealing head has a ring shape and defines a reinforcing rim at said sealing face that said breakable film is sealed and mounted at said reinforcing rim for preventing said breakable film being unintentionally torn apart when said sealing head is slid along said pipe.

7. The temporary sealer, as recited in claim 2, wherein said sealing head has a ring shape and defines a reinforcing rim at said sealing face that said breakable film is sealed and mounted at said reinforcing rim for preventing said breakable film being unintentionally torn apart when said sealing head is slid along said pipe.

8. The temporary sealer, as recited in claim 5, wherein said sealing head has a ring shape and defines a reinforcing rim at said sealing face that said breakable film is sealed and mounted at said reinforcing rim for preventing said breakable film being unintentionally torn apart when said sealing head is slid along said pipe.

9. The temporary sealer, as recited in claim 1, further comprising a retention frame extended from said sealing head at a direction opposite to said sealing face thereof, wherein said retention frame comprises a retention ring having a size and shape corresponding to an inner diameter of a pipe, and an extension frame extended between said sealing head and said retention ring, in such a manner that when said sealing head is slid within said pipe, said retention ring is adapted to retain an orientation of said breakable film squaring to said pipe.

10. The temporary sealer, as recited in claim 3, further comprising a retention frame extended from said sealing head at a direction opposite to said sealing face thereof, wherein said retention frame comprises a retention ring having a size and shape corresponding to an inner diameter of a pipe, and an extension frame extended between said sealing head and said retention ring, in such a manner that when said sealing head is slid within said pipe, said retention ring is adapted to retain an orientation of said breakable film squaring to said pipe.

11. The temporary sealer, as recited in claim 8, further comprising a retention frame extended from said sealing head at a direction opposite to said sealing face thereof, wherein said retention frame comprises a retention ring having a size and shape corresponding to an inner diameter of a pipe, and an extension frame extended between said sealing head and said retention ring, in such a manner that when said sealing head is slid within said pipe, said retention ring is adapted to retain an orientation of said breakable film squaring to said pipe.

12. The temporary sealer, as recited in claim 9, wherein said extension frame comprises a plurality of extension arms spacedly extended from said sealing head to said retention ring to define a water passage between every two neighboring extension arms for enabling said water passing through said water passages when said breakable film is torn apart.

13. The temporary sealer, as recited in claim 10, wherein said extension frame comprises a plurality of extension arms spacedly extended from said sealing head to said retention ring to define a water passage between every two neighboring extension arms for enabling said water passing through said water passages when said breakable film is torn apart.

14. The temporary sealer, as recited in claim 11, wherein said extension frame comprises a plurality of extension arms spacedly extended from said sealing head to said retention ring to define a water passage between every two neighboring extension arms for enabling said water passing through said water passages when said breakable film is torn apart.

15. The temporary sealer, as recited in claim 9, wherein said extension frame comprises a spiral shaped compression spring having two ends coupling with said sealing head and said retention ring respectively to define a water passage between every two spiral portions of said compression spring for enabling said water passing through said water passages when said breakable film is torn apart.

16. The temporary sealer, as recited in claim 10, wherein said extension frame comprises a spiral shaped compression spring having two ends coupling with said sealing head and said retention ring respectively to define a water passage between every two spiral portions of said compression spring for enabling said water passing through said water passages when said breakable film is torn apart.

17. The temporary sealer, as recited in claim 11, wherein said extension frame comprises a spiral shaped compression spring having two ends coupling with said sealing head and said retention ring respectively to define a water passage between every two spiral portions of said compression spring for enabling said water passing through said water passages when said breakable film is torn apart.

18. The temporary sealer, as recited in claim 1, wherein said sealing head further comprises a sealing ring encirclingly coupled at an outer circumferential surface of said sealing head for biasing against an inner wall of said pipe so as to provide a water sealing effect when said sealing head is slid within said pipe.

19. The temporary sealer, as recited in claim 14, wherein said sealing head further comprises a sealing ring encirclingly coupled at an outer circumferential surface of said sealing head for biasing against an inner wall of said pipe so as to provide a water sealing effect when said sealing head is slid within said pipe.

20. The temporary sealer, as recited in claim 17, wherein said sealing head further comprises a sealing ring encirclingly coupled at an outer circumferential surface of said sealing head for biasing against an inner wall of said pipe so as to provide a water sealing effect when said sealing head is slid within said pipe.
